(19) United States
(12) Patent Application Publication
(10) Pub. No.: US 2004/0212157 A1
(43) Pub. Date: Oct. 28, 2004

(54) Sealing material for gaskets as well as a flat gasket with such sealing material

(76) Inventors: Peter Bohringer, Hulben (DE); Jurgen Weingartner, Neuffen (DE); Hans-Rainer Zerfass, Taunusstein (DE); Wilhelm Kullen, Hulben (DE); Jochen Schollhammer, Dettingen (DE); Fritz Epple, Reutlingen (DE)

Correspondence Address: Edward J. Timmer, Walnut Woods Centre, 5955 West Main Street, Kalamazoo, MI, 49009, US

(21) Appl. No.: 10/827,775

(22) Filed: Apr. 20, 2004

(30) Foreign Application Priority Data
Apr. 25, 2003 (DE) 103 18 782.0

(51) Int. Cl. F16J 15/46

(52) U.S. Cl. 277/645

(57) ABSTRACT

Sealing material for application to a sealing surface of a gasket and/or a machine component, wherein problems with respect to the portioning and handling of the sealing material are avoided in that the sealing material has the form of a capsule filled with a fluid to pasty sealing substance and having a capsule wall bursting under the influence of pressure and the sealing substance can be hardened in situ under operating conditions.

The present disclosure relates to the subject matter disclosed in German application No. 103 18 782.0 of Apr. 25, 2003, which is incorporated herein by reference in its entirety and for all purposes.

### BACKGROUND OF THE INVENTION

Machine components, which have to be sealed in relation to one another, form a so-called sealing gap with sealing surfaces, a flat gasket being clamped between the machine components in order to seal this gap. If the width of this sealing gap has a discontinuity at a certain place, the sealing gap can often not be sealed adequately at this place with a conventional flat gasket, particularly when the sealing gap widens at this point in a step-like manner. Reciprocating combustion engines with a so-called chain case, with which a sealing gap between engine block, chain case and cylinder head must be sealed by means of a single gasket, namely a cylinder head gasket, are typical for this case; in the case of a typical engine of this type, a lower part of the chain case borders on the engine block and an upper part of the chain case on the cylinder head and so the specified sealing gap is limited, on the one hand, by sealing surfaces of the engine block and the lower part of the chain case and, on the other hand, by sealing surfaces of the cylinder head and the upper part of the chain case. On account of production tolerances, the sealing surface of the lower part of the chain case is not aligned exactly with the sealing surface of the engine block and/or the sealing surface of the upper part of the chain case is not aligned exactly with the sealing surface of the cylinder head; a discontinuity in the width of the sealing gap also results, however, when the lower part of the chain case is in one piece with the engine block or the upper part of the chain case is in one piece with the cylinder head and only one part of the chain case forms a separate engine component which is to be mounted as such.

When so-called soft material gaskets are used as cylinder head gaskets, differences in height between adjacent sealing surfaces (which are in the order of magnitude of one to several 10ths of a millimeter) caused by such production tolerances may be bridged relatively well since soft material gaskets of this type are relatively compressible and, consequently, an effective adaptation of the height can take place during the installation of a gasket. For some time now, the trend has, however, been towards using essentially metallic flat gaskets, the gasket plate of which consists essentially of one or several sheet-metal layers placed one on top of the other, and in the case of such metallic flat gaskets the specified discontinuities in the width of the sealing gap lead to considerable sealing problems—the customary sealing elements of such sheet-metal layers, namely beads which are deformable in their height in a spring-elastic manner and are impressed into a sheet-metal layer, are not in a position to bridge a step-like increase in the width of the sealing gap such that no leakage occurs.

A sealing problem of a similar type also results when a sealing gap limited by two sealing surfaces abuts on another sealing gap likewise limited by sealing surfaces, thereby forming a so-called T junction, and both sealing gaps are intended to be sealed by means of flat gaskets because the point, at which the one flat gasket of one sealing surface ends adjacent to the other flat gasket, cannot be sealed reliably with the two gaskets. In this case, as well, the width of the one sealing gap has a discontinuity, namely at least at that point where the other sealing gap opens into this one sealing gap.

Several suggestions, by means of which the problem described in the above and caused by joint areas is intended to be solved, already result from the state of the art:

EP-A-0 059 777, DE-C-43 37 758 and EP-B-0 701 051 disclose suggestions for solutions, according to which prefabricated, elastomeric sealing elements, which are mainly bar-shaped, are inserted into recesses of gasket plates and bridge the specified joint areas; prefabricated, elastomeric sealing elements of this type are, however, adaptable only to a limited extent and so pronounced, step-like discontinuities in the width of the sealing gap can often not be sealed reliably with them.

During the assembly of engines having chain cases consisting of an upper part and a lower part, it has already been attempted to resolve the problem described above in that the cylinder head gasket is provided on both sides of the chain case apertures with a respective, relatively small, oval hole which extends through all the layers of the multi-layered, metallic cylinder head gasket and into which a sealant, which is, first of all, viscous and can be hardened to form an elastomeric material at elevated temperatures, i.e., for example, during the initial operation of the engine, is injected during the course of the assembly of the engine. It is, however, quite obvious that such a procedure during assembly of the engine in series production is unsatisfactory, namely for several reasons: Vehicle manufacturers tend nowadays to shift as many operating steps as possible to their suppliers and during series production it is also difficult, at least, however, time-consuming, to always inject the amount of sealant required for a reliable seal into the specified holes.

In order to avoid these disadvantages, the ElringKlinger AG has already proposed in DE-A-100 46 505 to provide apertures in the gasket plate of an at least essentially metallic cylinder head gasket at the place where at least a lower part of a chain case borders on an engine block and to apply to the gasket plate a respective strand of hardenable sealing material which hardens in situ to form an elastomeric material under operating conditions of the gasket. It is, however, quite obvious that the handling properties of such a gasket leave much to be desired for as long as the sealing material has not hardened completely to form an elastomeric material.

### SUMMARY OF THE INVENTION

In order to overcome all these problems, the present invention proposes a sealing material for application to a sealing surface of a gasket and/or a machine component which sealing material is characterized by the fact that it has the form of a capsule filled with a fluid to pasty sealing substance with a capsule wall bursting under the influence of pressure and the sealing substance is a material settable or hardenable in situ under its operating conditions.

The inventive capsule sealing material may be applied to any optional place of a gasket or a machine component, e.g., by means of a small, punctiform amount of adhesive; capsules of this type and gaskets or machine components provided with such capsules are easy to handle since the capsules are not sticky, in contrast to a sealing material which is not hardened until later, and the volume of sealing substance enclosed by the capsule may be freely selected by way of a corresponding dimensioning of the size of the capsule but, on the other hand, predetermined so that the dimensioning problem, which is given in the case of the known method last described in the above, does not apply.

The capsule must, of course, contain such an amount of sealing substance that this amount suffices to fill the place which is problematic from the point of view of sealing technology reliably and, where possible, the capsule should contain a little more sealing substance than is absolutely required.

The capsule must, of course, be adapted in its shape and size to the place of installation so that it bursts during the assembly and tightening, i.e., the clamping of the gasket in the sealing gap so that the fluid to pasty sealing substance can fill that cavity between the machine components and the actual gasket which is to be sealed and is not filled by the actual gasket during the deformation of the gasket during the clamping procedure.

The sealing substance is preferably a material which hardens or solidifies under the influence of temperatures higher than room temperature and/or of moisture, such as humidity, and then forms, in particular, an elastomeric sealing material. Methods for encapsulating optional substances are known from the field of the pharmaceutical industry but also from other fields, in particular for the case of capsules with a capsule wall consisting of gelatin. The capsule wall can, however, also consist of a thin plastic film, in particular, of a thin polyethylene film, from which a cushion-like or tube-like capsule, which contains the fluid to pasty sealing substance, may be produced, for example, by means of (preferably thermal or ultrasonic) welding or adhesion. Such a plastic film decomposes more or less free from residue following the bursting of the capsule wall during the course of assembly of the gasket, e.g., at the high operating temperatures of a combustion engine and the same applies, for example, for gelatin as capsule wall material. Embodiments of the inventive sealing material are, therefore, preferred, with which the capsule wall consists of a material which decomposes and/or becomes fluid to pasty and/or dissolves under operating conditions of the sealing substance—if the capsule wall becomes fluid to pasty, the capsule wall material is displaced by the sealing substance under operating conditions after assembly of the gasket. If the capsule wall consists of a material which dissolves under the influence of the sealing substance, a premature destruction of the capsule wall is prevented by the fact that this has an inner coating which is inert with respect to the sealing substance so that the material of the actual capsule wall is not dissolved by the still fluid to pasty sealing substance until after the capsule has burst.

For the sealing of a place which is problematic with respect to its sealing, one inventive capsule or several such capsules can be used; for the cases described in the above a sealing material is, however, recommended, with which a single capsule is sufficient for sealing a problem location, which is the case when, as in preferred embodiments, the capsule contains approximately 10 to 30 mm³ of sealing substance.

As already results from the above, the invention also relates to a flat gasket, both sides of which form sealing surfaces and which is characterized by the fact that an inventive sealing material in the form of at least one capsule is secured to at least one place on at least one side of the gasket. As has likewise already been mentioned, the capsule can be adhered to the gasket; where applicable, it may be recommendable to configure the gasket plate of the flat gasket such that this has a recess for the partial accommodation of the capsule in at least one of its main surfaces, wherein the recess and the capsule must, of course, be coordinated with one another such that the capsule bursts reliably during the installation of the flat gasket.

As results from the above comments, as a result of the encapsulating of the fluid to pasty sealing substance this can already be applied to the gasket by the producer of the latter. During the installation of the gasket, the sealing substance can flow to the spot to be sealed after the capsule has burst and be distributed in accordance with the pressure conditions prevailing at this point. Superfluous sealing substance is either displaced outwards beyond the edge of the flat gasket or distributed in the sealing gap beyond the point to be sealed so that the amount of sealing substance can be adapted in an optimum manner to the installation conditions. Since the optimum amount of sealing substance is present at the spot to be sealed by the inventive sealing material when a gasket is installed, the sealing element formed by the sealing substance following its hardening can, in contrast to the known, prefabricated, elastomeric sealing elements mentioned in the above, either not be damaged or at least only slightly by dynamic stresses without the sealing properties essentially deteriorating as a result.

The encapsulated sealing substance is preferably selected such that it adheres to the adjoining surface areas of the flat gasket and the machine components once the capsule has burst under operating conditions and so the displacement movements between the various components caused by dynamic stressing cannot have any disadvantageous effect, above all when an elastomeric material results from the sealing substance after its hardening.

As already indicated, an inventive flat gasket can also be provided on its two sides with an inventive, capsule-like sealing material.

Additional, preferred embodiments of the invention result from the attached claims.

Reference should also be made to the fact that the invention relates not only to sealing material for essentially metallic flat gaskets or to such flat gaskets but likewise to sealing material for other gaskets or to flat gaskets, the gasket plate of which consists completely or partially of non-metallic materials, as is the case for so-called soft material gaskets.

In the following, preferred embodiments of the invention will be explained in greater detail on the basis of the attached drawings, wherein additional, advantageous features of the invention result from the following description and these drawings.

### BRIEF DESCRIPTION OF THE DRAWINGS

FIG. 1 shows a schematic section through areas of three machine components which form a so-called T junction and define two sealing gaps, wherein the sealing by means of the inventive sealing material takes place at the junction, namely after a capsule has burst and the sealing substance previously enclosed in the capsule released;

FIG. 2 shows a section through part of the gasket plate of a flat gasket, wherein a capsule-like inventive sealing material is attached to this part;

FIG. 3 shows an illustration similar to FIG. 2 but with a gasket plate formed by two layers;

FIG. 4 shows a section through an inventive capsule-like sealing material, with which the actual capsule has been produced from a coated plastic film;

FIG. 5 shows a plan view of part of an inventive cylinder head gasket which comprises two combustion chamber apertures as well as a chain case aperture of the gasket;

FIG. 6 shows a perspective illustration of parts of a so-called hood gasket as well as adjoining engine components in the form of an exploded drawing, and

FIG. 7 shows the parts shown in FIG. 6 but without the hood, wherein so-called T junctions to be sealed by the hood gasket have been marked by dashed circles.

### DETAILED DESCRIPTION OF THE INVENTION

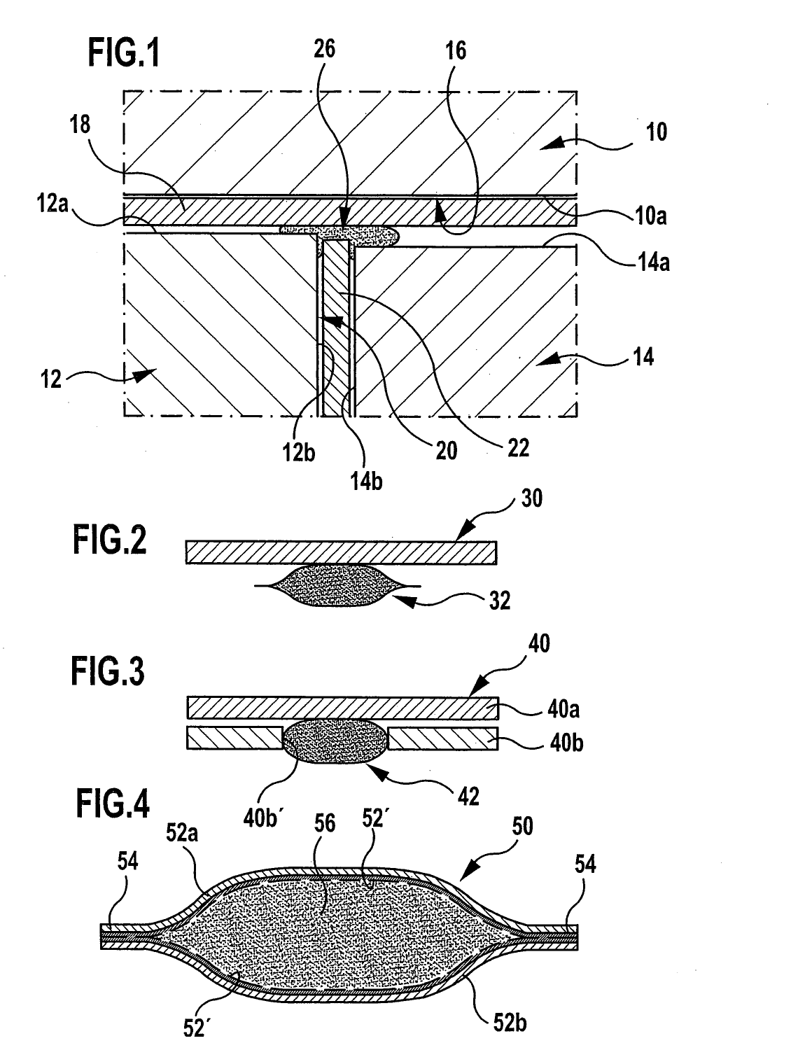

FIG. 1 shows a first, a second and a third machine component 10, 12 and 14, respectively, which together limit a first sealing gap 16, in which a first flat gasket 18 is clamped. The second and third machine components 12 and 14, respectively, enclose between them a second sealing gap 20, in which a second flat gasket 22 is clamped which extends transversely to the first flat gasket 18 and ends at a very slight distance from the latter. The sealing surfaces of the three machine components limiting the sealing gap have been designated as 10a or 12a and 12b or 14a and 14b.

As is apparent from FIG. 1, the sealing surfaces 12a and 14a limiting the first sealing gap 16 on its one side extend parallel to one another but they are not flush with one another; on the contrary, the sealing surface 14a is located in FIG. 1 somewhat lower than the sealing surface 12a and so the width of the first sealing gap 16 has a step-like discontinuity at the transition from the sealing surface 12a to the sealing surface 14a. At the location of this discontinuity, i.e., at the step-like transition from the sealing surface 12a to the sealing surface 14a, the cavity otherwise present between the flat gasket 18 and the upper edge of the flat gasket 22 is filled by a sealing element 26 which preferably consists of an elastomeric material and for the formation of which a capsule-like sealing material in accordance with the present invention has been used—FIG. 1 is intended to illustrate the state which results after a certain period of operation of the machine which comprises the machine components 10 to 14.

Preferred embodiments of the inventive sealing material will now be explained in greater detail on the basis of FIGS. 2 to 4.

FIG. 2 shows part of a one-layered gasket plate 30 of a flat gasket, to the one main surface of which an inventive capsule filled with a sealing substance has been attached, e.g., adhered. On the assumption that the gasket plate 30 is the gasket plate of the first flat gasket 18 illustrated in FIG. 1, the capsule 32 is located at such a place on the flat gasket, at which the sealing element 26 illustrated in FIG. 1 is located after its installation. The capsule 32 is an element having an approximately cushion-like shape, the structure of which will be described in greater detail in the following on the basis of FIG. 4.

FIG. 3 shows an alternative to the embodiment illustrated in FIG. 2, namely part of a two-layered gasket plate 40 with two sheet-metal layers 40a and 40b, the latter of which has an opening 40b′, into which an inventive capsule 42 has been placed. The latter can, for example, be a gelatin capsule which has a filling consisting of an inventive sealing substance—the type and production of such capsules with a gelatin wall are well known, e.g., from the pharmaceutical industry. The capsule 42 can be secured to the gasket plate 40, e.g., to its layer 40a by means of a small amount of adhesive; it is, however, also conceivable to coordinate the capsule and the opening 40b′ with one another such that the capsule is held in a clamped manner in the opening. The capsule 42 must, of course, protrude beyond the lower main surface of the gasket plate 40 such that it bursts during the installation of the flat gasket, i.e., when this is clamped between machine components and releases its content of inventive sealing substance.

FIG. 4 shows a section through an inventive capsule 50 with a filling consisting of inventive sealing substance. The capsule has the shape of a flat, small cushion, produced from two thin plastic films 52a and 52b which are welded or adhered to one another and have been connected sealingly to one another along the capsule circumference at 54. The inventive, still fluid to pasty sealing substance forming the capsule filling has been designated as 56. The substances are intended to have been selected in the case of this embodiment such that the plastic films forming the capsule wall dissolve or decompose when they are subjected to the fluid to pasty sealing substance 56. So that the wall of the capsule 50 does not dissolve prematurely, the plastic films 52a and 52b have on their respective inner sides a coating 52′ which is inert with respect to the sealing substance 56 and protects the plastic films against any premature attack.

Typically, the inventive capsule contains between 10 and 30 mm³ of sealing substance, preferably between 10 and 20 mm³.

Plastics and gelatin, in particular, are possibilities as material for the capsule wall, in general materials which do not impair, or at least not appreciably, the sealing effect of the sealing substance after the capsule has burst in the operating state of the gasket.

Fluid elastomers which are not yet cross-linked to a great extent are recommended as sealing substances, such as, e.g., silicon compounds but also acrylates. In general, fluid to pasty materials are recommended which harden to form an, in particular, elastomeric sealing material either under the influence of H₂O (in particular, humidity) or as a result of other influences, e.g., at elevated temperatures. The case, in which the capsule wall contains a substance or substances, under the influence of which the fluid to pasty sealing substance hardens (is cross-linked), is also conceivable. Examples of silicon compounds are the products available on the market under the product names Loctite 5900 (obtainable from the Loctite Deutschland GmbH company, Arabellastrasse 17, 81925 Munich) and Pactan 7076 (obtainable from the Heidelberger Bauchemie company, 83301 Traunreut), examples of acrylates the products available on the market under the product names Loctite 574 (obtainable from the Loctite Deutschland GmbH company, Arabellastrasse 17, 81925 Munich) and Epple 40 (obtainable from the Epple Chemie company, Hertzstrasse 8, 71083 Herrenberg).

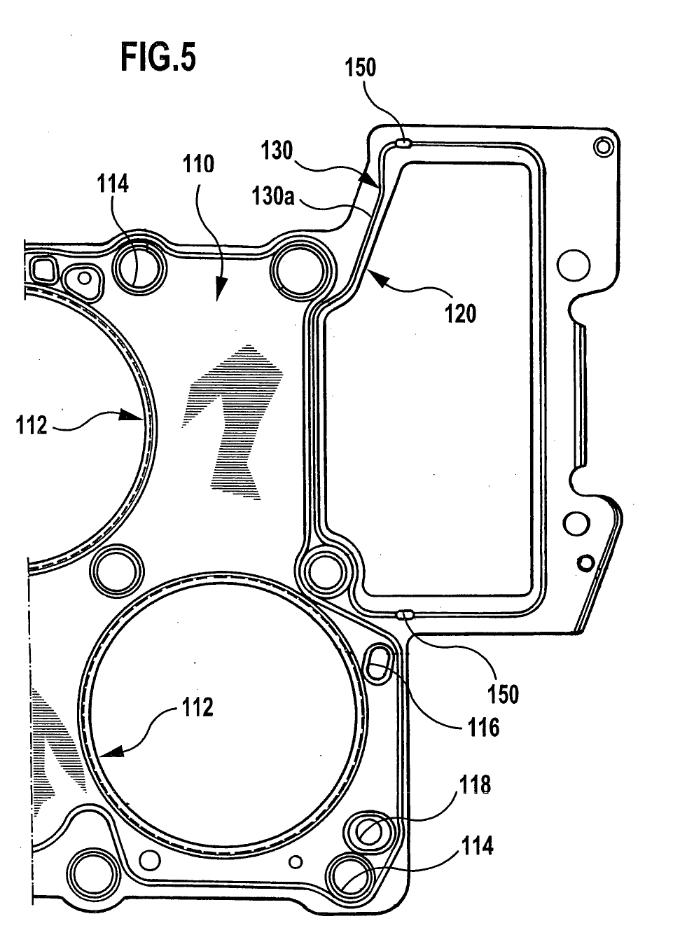

The cylinder head gasket partially illustrated in FIG. 5 has a gasket plate, which is designated as a whole as 110 and in which a plurality of apertures passing through the gasket plate are formed, such as, e.g., combustion chamber apertures 112, bolt holes 114 for the passage of cylinder head bolts and holes for water or oil 116 and 118. In addition, the cylinder head gasket includes a chain case aperture 120, around which sealing surfaces of an upper part of the chain case which is not illustrated and of an adjoining cylinder head which is likewise not illustrated as well as of a lower part of the chain case which is not illustrated and of an adjoining engine block which is not illustrated are to be sealed relative to one another by the cylinder head gasket. For the sake of simplicity it is assumed that the gasket plate 110 has one layer and is formed from sheet steel having elastic properties.

A bead 130 extends around the chain case aperture 120 in the gasket plate 110, namely a so-called semi-bead which forms a complete bead line and the crest of which has been designated as 130a. The gasket plate 110 has in the area of the bead 130 above or below that place, at which engine block and lower part of the chain case or cylinder head and upper part of the chain case butt on one another, apertures which are not illustrated in FIG. 5 and in which a respective, inventive sealing material capsule 150 is arranged. These capsules are dimensioned with respect to the volume of sealing substance accommodated in them such that they burst during the clamping of the cylinder head gasket and release adequate amounts of sealing substance on both sides of the gasket plate 110 to provide for a reliable seal at the specified joint areas.

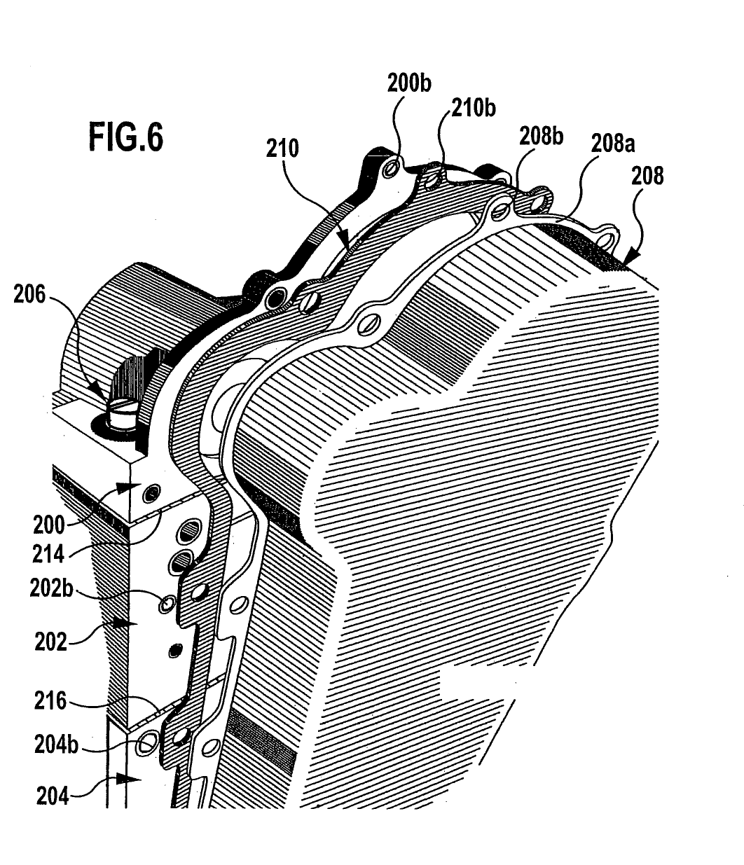

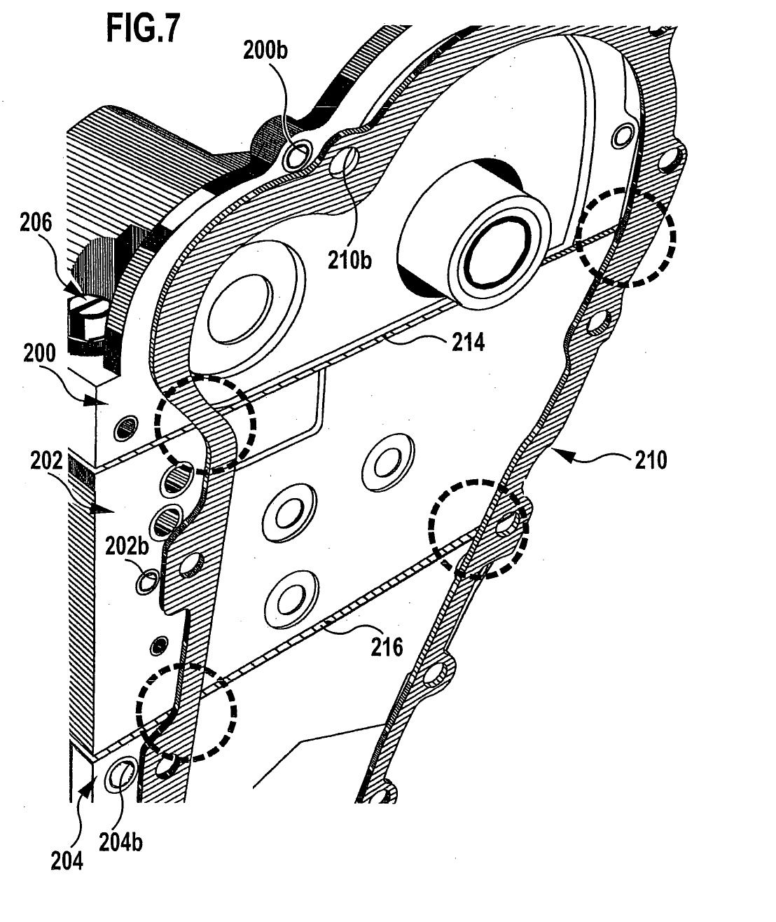

FIGS. 6 and 7 serve merely to further clarify the sealing problems at so-called T junctions which are intended to be sealed by means of a flat gasket which is not a cylinder head gasket.

FIG. 6 shows three engine components 200, 202 and 204, which are connected to one another by means of tightening screws 206, of which only one is apparent, a hood 208 as well as a flat gasket 210 which is to be clamped between the hood and the engine components 200, 202 and 204 and has, altogether, a frame-like shape. Screw holes 208b are provided in a flange 208a of the hood 208, the flat gasket 210 has screw holes 210b and the engine components 200, 202 and 204 are provided with screw holes 200b, 202b and 204b, respectively, which are intended to be threaded bores in order to be able to clamp the flat gasket 210 between the hood 208, on the one hand, and the specified engine components, on the other hand, and secure the hood.

A respective flat gasket 214 or 216 is clamped between the engine components 200 and 202 as well as between the latter and the engine component 204 (the required pressure is generated with the aid of the tightening screws 206) so that a respective T junction (defined in the above), at which the flat gasket 210 extends beyond one of the flat gaskets 214 and 216, results at the places marked in FIG. 7 with dashed circles. The flat gasket 210 is intended to be designed in accordance with the invention at these T junctions although this is not apparent in FIGS. 6 and 7.

It is also understandable on the basis of FIG. 2 that the inventive, encapsulated sealing substance can also be encapsulated between a surface of the gasket plate 30 (in the case of a multi-layered gasket plate between a surface of one layer of the gasket plate) and a thin film, coat of point or the like which is connected securely and sealingly to the gasket plate (or the specified layer of the gasket plate) around the sealing substance; in this connection it should also be pointed out that the gasket plate (or the specified layer of the gasket plate) may be provided with a coating, on which the sealing substance is then arranged and to which the specified film or the like is connected, e.g., by way of adhesion or welding. The term “capsule” is, therefore, not to be understood only as a capsule in a conventional sense.

The capsule provided in accordance with the invention may also enclose two chambers which are separated from one another by a suitable, thin separating wall, e.g., in the form of a thin film and contain two components of the sealing substance which do not come into contact with one another until the capsule is destroyed due to the effect of pressure. Sealing substances, which harden without the access of air or moisture or without the use of elevated temperatures, may be used for such an embodiment and reference is made only by way of example to EP-B-0 140 006, in which multicomponent sealing masses hardening in the absence of oxygen are described.

When it is specified above with respect to the definition of the present invention that the sealing substance can be hardened in situ under operating conditions, this is, of course, also to be understood to include the case where, when using a multicomponent sealing substance, this hardens subsequent to the assembly of the gasket or the machine components without elevated temperatures and the access of any other medium being required for this purpose.

1. Sealing material for application to a sealing surface of a gasket and/or a machine component, wherein the sealing material has the form of a capsule filled with a fluid to pasty sealing substance and having a capsule wall bursting under the influence of pressure and the sealing substance is settable in situ under operating conditions.

2. Sealing material as defined in claim 1, wherein the capsule wall consists of a material decomposing and/or becoming fluid to pasty and/or dissolving under operating conditions of the sealing substance.

3. Sealing material as defined in claim 1, wherein the capsule wall consists of a material dissolving under the influence of the sealing substance and that the capsule has an inner coating inert with respect to the sealing substance.

4. Sealing material as defined in claim 1, wherein the capsule contains approximately 10 to 30 mm³ of sealing substance.

5. Flat gasket, both sides of said gasket forming sealing surfaces, wherein a sealing material as defined in claim 1 is secured to at least one place on at least one side of the gasket.

6. Flat gasket as defined in claim 5, wherein the capsule is bonded to the gasket.

7. Flat gasket as defined in claim 5 for the sealing of a sealing gap formed between sealing surfaces of machine components, the width of said sealing gap have a discontinuity at at least one place, wherein the capsule is secured to a place on the gasket located in the area of the discontinuity of the sealing gap in the installed state of the gasket.

8. Cylinder head gasket as defined in claim 7, comprising a chain case aperture for an engine having a chain case, one area of said chain case being formed by a part of the chain case designed as a separate part, this resulting in the formation of at least one joint area in one of the sealing surfaces forming a sealing gap for accommodating the cylinder head gasket, wherein the capsule is secured to a place on the cylinder head gasket located over the joint area when the gasket is installed.

9. Cylinder head gasket as defined in claim 7 for an engine with components forming at least one T junction in the area of a first sealing gap limited by component sealing surfaces and being sealable by the cylinder head gasket, a second sealing gap extending transversely to the first sealing gap, being sealable by a second flat gasket and opening into the first sealing gap at said junction, wherein the capsule is secured to a place on the cylinder head gasket located over the junction area when the gasket is installed.

10. Flat gasket as defined in claim 5, said flat gasket having a gasket plate, wherein the gasket plate has in at least one of its main surfaces a recess for partially accommodating the capsule.
